(19) United States
(12) Patent Application Publication
(10) Pub. No.: US 2011/0181720 A1
(43) Pub. Date: Jul. 28, 2011

(54) SYSTEM, METHOD, AND COMPUTER PROGRAM PRODUCT FOR TRACKING MOBILE OBJECTS FROM AN AERIAL VEHICLE

(76) Inventors: Christopher M. Edgeworth, Longview, TX (US); Ron Johnston, Longview, TX (US)

(21) Appl. No.: 13/013,718

(22) Filed: Jan. 25, 2011

Related U.S. Application Data
(60) Provisional application No. 61/298,033, filed on Jan. 25, 2010.

(51) Int. Cl. H04N 7/18; G01C 21/02; G01J 5/10; G06K 9/60

(52) U.S. Cl. 348/144; 250/206.1; 250/338.1; 382/103; 348/E07.085

(57) ABSTRACT

A system, method, and computer program product are provided for determining the location of a mobile object moving beneath an aerial vehicle. In operation, a mobile object is sensed utilizing one or more sensors coupled to an aerial vehicle. Additionally, an object signature for the mobile object is generated utilizing signals received from the one or more sensors. Furthermore, the mobile object is tracked utilizing the object signature.

### FIELD OF THE INVENTION

This present invention relates to sensing a mobile object utilizing one or more sensors coupled to an aerial vehicle, generating an object signature for that mobile object, and tracking that mobile object as it moves about, utilizing that mobile signature and various positioning methods.

### BACKGROUND

The issue of being able to track mobile objects as they move about, and know their location, has a variety of useful benefits. These may relate to safety, sport, useful information, or other connected criteria.

There is thus a need for addressing these and/or other issues associated with the prior art.

### SUMMARY

A system, method, and computer program product are provided for determining the location of a mobile object moving beneath an aerial vehicle.

### BRIEF DESCRIPTION OF THE DRAWINGS

FIG. 1 shows a process for identifying and tracking a mobile object from an aerial vehicle.

FIG. 2 shows the flow of an embodiment where a sensor is used to detect a mobile object. Information is transmitted to a computer system to determine its position.

FIG. 3 shows an embodiment where an infrared sensor is used to detect the mobile object, a computer system determines the position of the mobile object and the aerial vehicle, and a control algorithm is utilized to activate and control the aerial vehicle flight to track the mobile object.

FIG. 4 shows an embodiment where the computer system and flight control are on board the aerial vehicle. A base station receives the computed information, displays position of the mobile object, and initializes and modifies the control conditions.

FIG. 6 illustrates an exemplary system in which the various architecture and/or functionality of the various previous embodiments may be implemented. This contains the processing, tracking algorithms, memory, graphics and display functions necessary to track the mobile object.

### DETAILED DESCRIPTION

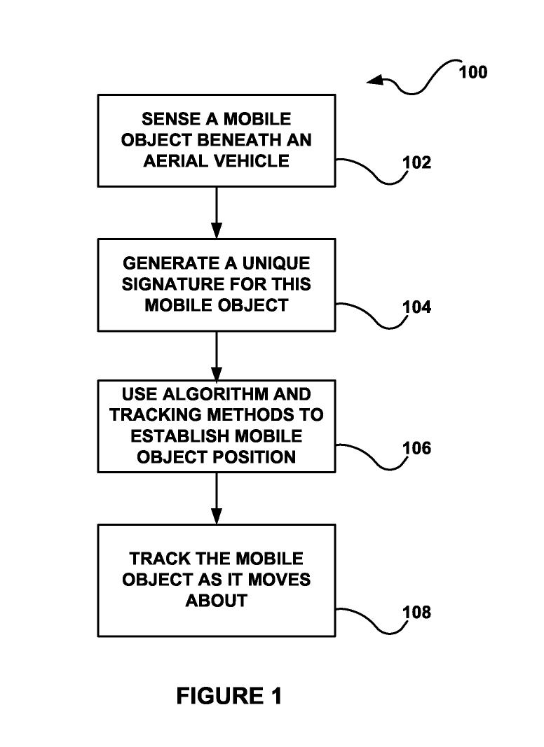

FIG. 1 shows a method 100 for identifying and tracking a mobile object from an aerial vehicle, and the processes used to accomplish this. Process 102 involves an aerial vehicle capable of sensing a mobile object beneath it. This aerial vehicle may include a variety of airborne platforms including a balloon, blimp, hover craft, helicopter, plane, or other type of vehicle capable of sustaining flight above an earthbound mobile object. The method of sensing this mobile object may be accomplished in a variety of ways. Thermal or infrared sensing could be used. Also a CCD imaging may be utilized. Doping may further enhance the CCD sensor. Other means of sensing may also be utilized.

Process 104 demonstrates a method of generating a unique signature for this mobile object so that movement can be tracked. To obtain a signature, there may be means of distinguishing certain thermal, shape, size, or other physical factors that allow this object to have an unique identification. The type of sensor employed may also have an impact on how this signature is established.

Process 106 includes an algorithm that may be used to establish the position of the mobile object and future positions as this object is tracked. This algorithm implies that certain computational or computer elements and programs may be present somewhere in this system. This may include certain arrangements of hardware, databases, and other methods of transmitting and receiving pertinent information. It also implies that a means is established to control the flight of the aerial vehicle as the mobile object moves about.

Process 108 indicates the procedure of tracking the mobile object. This may be accomplished by the aerial vehicle following the mobile object as it moves about. Also, but not limited to, the aerial vehicle may stay in a fixed position for a specified range, then move to a closer position as the mobile object moves toward the limits of this range. Limits of tracking may also be imposed so as to constrain the tracking area, or other means may be established to increase naturally and artificially occurring transmitting/receiving confines.

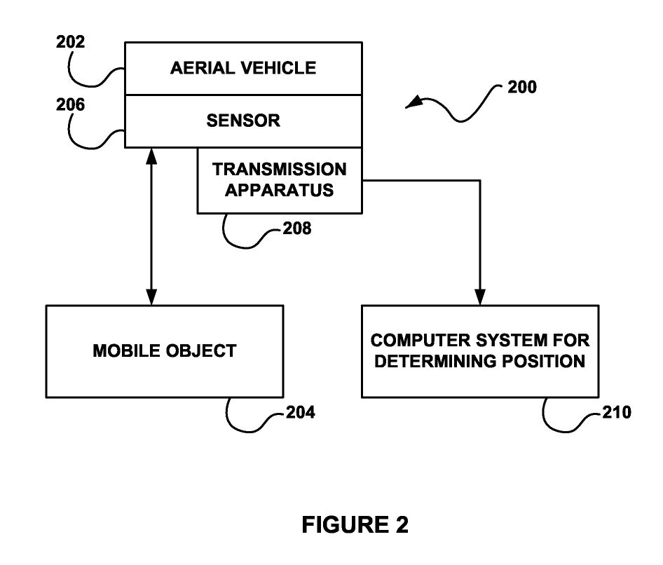

FIG. 2 shows a method 200, in accordance with one embodiment. As shown, aerial vehicle 202 may contain a sensor 206 capable of detecting a mobile object 204 below. The sensor 206 may be a thermal sensor, infrared sensor, CCD (charge-coupled device) array, a doped CCD, a combination of the previous, or other sensors capable of detecting and identifying an object below an aerial vehicle. The aerial vehicle 202 may include a balloon, a blimp, a hover craft, a helicopter, a plane or any device capable of maintaining flight. The aerial vehicle may be manned, or it may be unmanned and be operated remotely. The mobile object 204 may include an animal, or it may include a human, or it may include another vehicle. The sensor 206 may be attached to a transmission apparatus 208, which may be used to transmit sensor information to a computer system 210 for determining the position of the mobile object.

This computer system 210 may include suitable programs, algorithms, and database, suitable for determining the position of the mobile object. It may also include memory and readable display mediums so the object position may be monitored and tracked.

More illustrative information will now be set forth regarding various optional architectures and features with which the foregoing framework may or may not be implemented, per the desires of the user. It should be strongly noted that the following information is set forth for illustrative purposes and should not be construed as limiting in any manner. Any of the following features may be optionally incorporated with or without the exclusion of other features described.

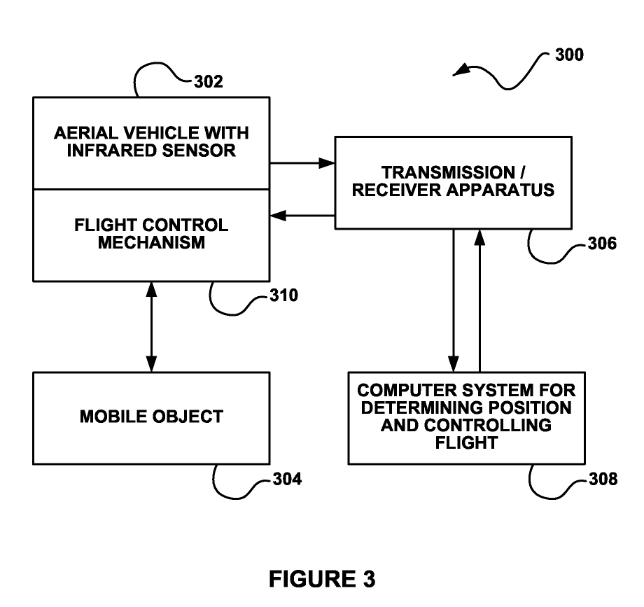

FIG. 3 shows a system 300 for tracking a mobile object 304 with an aerial vehicle 302 that includes a remote controlled flight mechanism 310 of the aerial vehicle. In this illustration, an infrared sensor is utilized for sensing the mobile object 304. A transmission/receiving apparatus 306 may be used to transmit the information sensed concerning the mobile object 304 to computer system 308.

The computer system 308 may contain algorithms and stored data that is used to determine the position of the mobile object from the sensor data. In turn, location information is utilized to control the flight mechanism 310 of the aerial vehicle 302. As the mobile object 304 moves about, the flight control mechanism 310 manages the specified position of the aerial vehicle 302. This may be accomplished by transmitting the specified control back to the receiver apparatus 306, which in turn is used to control the flight. It should also be noted that this specified embodiment may be modified to fit a variety of environments. It is obvious that the computer system 308 must contain a means for receiving information from the aerial vehicle, and transmitting information back. The mobile object, type of aerial vehicle, and type of sensor device, may be any of the afore mentioned forms.

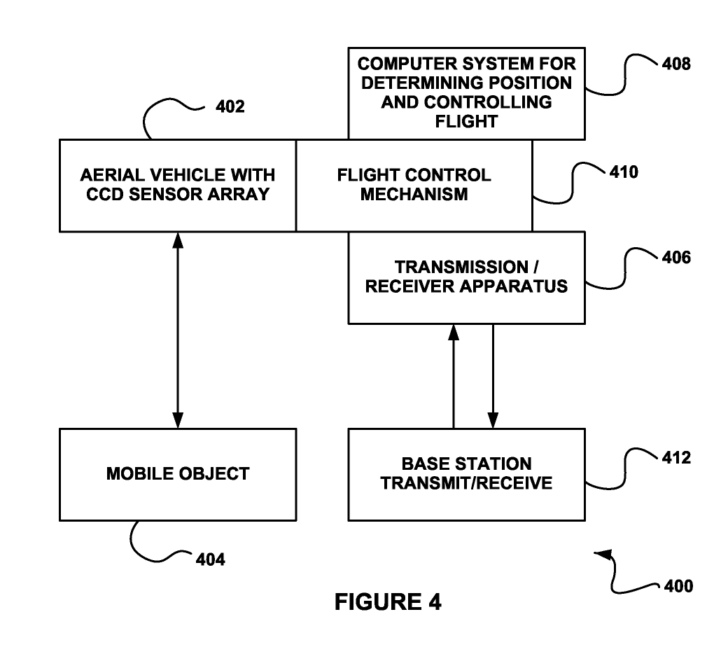

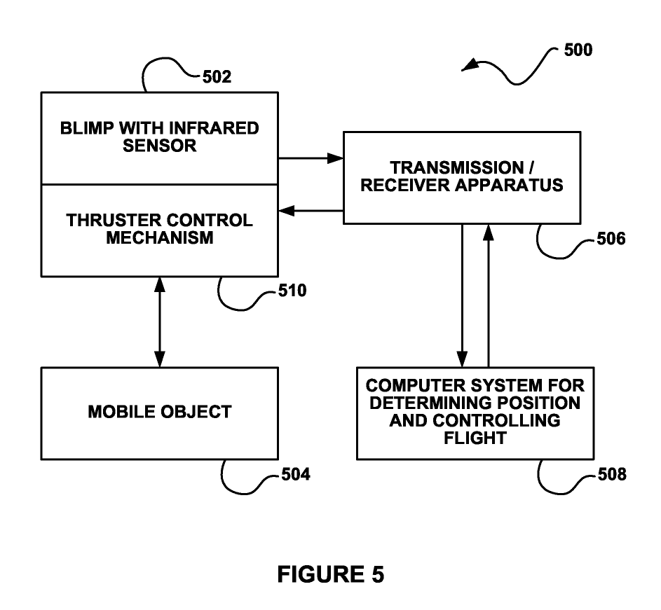

FIG. 4 shows a method 400 where the aerial vehicle 402 contains a CCD sensor array. In this embodiment the computer system 408 is on board the aerial vehicle. The flight control mechanism 410 is controlled by the on board computer system 408, which in turn sends transmissions through the transmitter/receiver apparatus 406 to a base station 412. The base station 412 has the capability of displaying the movement and location of the mobile object 404 as well as transmitting initialization and other pertinent commands to the on board computer system 408. Of course, the method 400 may be carried out in any desired environment, and may be implemented in the context and functionality and architecture of FIG. 3.

The base station 412 and computer system 408 may each contain modules of the computational system. The control algorithms, data base information, computational hardware and tracking procedures may reside in part in each of the described systems. The viability of the end result may dictate the best split of the various elements. As before stated, the mobile object, type of aerial vehicle, and type of sensor device, may be any of the aforementioned forms.

The type of aerial vehicle may have an effect on the type and operation of the controls utilized for flight. A helicopter or some type of hovercraft may use a different means of control than an airplane that will need continuous forward motion to maintain flight. A balloon or blimp will be susceptible to prevailing winds and will need controls (i.e., thrusters, rudders, impulse movements) to maintain position or change position. The type of aerial vehicle chosen may have an impact on the flight control methods used.

FIG. 5 illustrates a blimp used as the aerial vehicle 502 for tracking a mobile object 504. The blimp 502 is equipped with an infrared sensor, but it may also utilize a CCD or other variation of sensor to detect the mobile object. In this example, the flight control mechanism 510 is a thruster control. The thruster operation may be controlled by the ground based computer system 508, which contains the algorithms and data base information that are utilized to track the mobile object 504. A transmission/receiving apparatus 506 may be used to transmit the information sensed concerning the mobile object 504 to the computer system 508.

As the mobile object 504 moves about, the pertinent algorithms and stored information in the computer system 508 generate data to alter the location of the blimp 502, and thus track the mobile object 504. The transmission/receiver apparatus 506 may then receive the new location parameters, and energize the flight control of the blimp 510. It should also be noted that this specified embodiment may be modified to fit a variety of environments. It is obvious that the computer system 508 must contain a means for receiving information from the aerial vehicle, and transmitting information back. The mobile object, type of aerial vehicle, and type of sensor device, may be any of the afore mentioned forms.

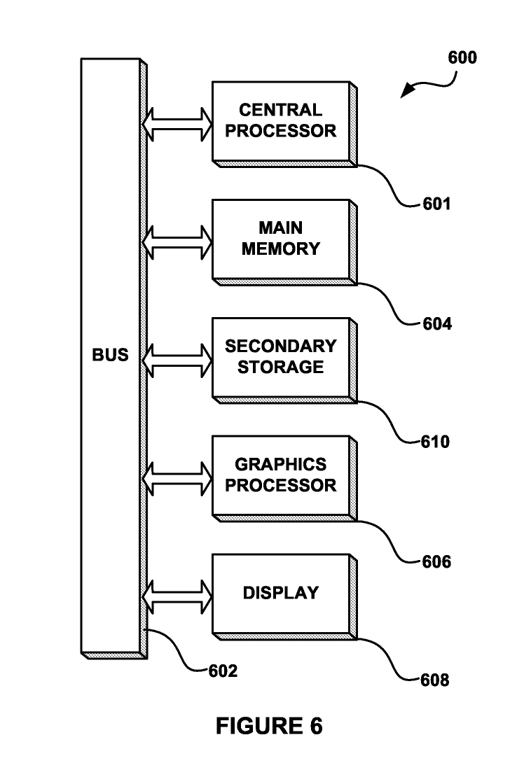

FIG. 6 illustrates an exemplary system in which the various architecture and/or functionality of the various previous embodiments may be implemented. As shown, a system is provided including at least one host processor 600 that is connected to a communication bus 602. The system 600 also includes a main memory 604. Control logic (software) and data are stored in the main memory 604 which may take the form of random access memory (RAM).

The system also includes a graphics processor 606 and a display 608 (e.g., a computer monitor). In one embodiment, the graphics processor 606 may include a plurality of shader modules, a rasterization module, etc. Each of the foregoing modules may even be situated on a single semiconductor platform to form a graphics processing unit (GPU).

In the present description, a single semiconductor platform may refer to a sole unitary semiconductor-based integrated circuit or chip. It should be noted that the term single semiconductor platform may also refer to multi-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user.

The system 600 may also include a secondary storage 610. The secondary storage 610 includes, for example, a hard disk drive and/or a removable storage drive, representing a floppy disk drive, a magnetic tape drive, a compact disk drive, etc. The removable storage drive reads from and/or writes to a removable storage unit in a well known manner.

Computer programs, or computer control logic algorithms, may be stored in the main memory 604 and/or the secondary storage 610. Such computer programs, when executed, enable the system 600 to perform various functions. Memory 604, storage 610 and/or any other storage are possible examples of computer-readable media.

In one embodiment, the architecture and/or functionality of the various previous figures may be implemented in the context of the host processor 600, graphics processor 606, an integrated circuit (not shown) that is capable of at least a portion of the capabilities of both the host processor 601 and the graphics processor 606, a chipset (i.e., a group of integrated circuits designed to work and sold as a unit for performing related functions, etc.), and/or any other integrated circuit for that matter.

Still yet, the architecture and/or functionality of the various previous figures may be implemented in the context of a general computer system, a circuit board system, a game console system dedicated for entertainment purposes, an application-specific system, and/or any other desired system. For example, the system may take the form of a desktop computer, lap-top computer, and/or any other type of logic. Still yet, the system may take the form of various other devices including, but not limited to, a personal digital assistant (PDA) device, a mobile phone device, a television, etc.

Further, while not shown, the system may be coupled to a network (e.g., a telecommunications network, local area network (LAN), wireless network, wide area network (WAN) such as the Internet, peer-to-peer network, cable network, etc.) for communication purposes.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method, comprising:
sensing a mobile object utilizing one or more sensors coupled to an aerial vehicle;
generating an object signature for the mobile object utilizing signals received from the one or more sensors; and
tracking the mobile object utilizing the object signature.

2. The method of claim 1, wherein the one or more sensors include a CCD array.

3. The method of claim 1, wherein the one or more sensors include thermal sensors.

4. The method of claim 1, wherein the one or more sensors include IR sensors.

5. The method of claim 1, wherein the one or more sensors include doped CCDs.

6. The method of claim 1, wherein the aerial vehicle includes a balloon.

7. The method of claim 1, wherein the aerial vehicle includes a blimp.

8. The method of claim 1, wherein the aerial vehicle includes a hover craft.

9. The method of claim 1, wherein the aerial vehicle includes a helicopter.

10. The method of claim 1, wherein the aerial vehicle includes a plane.

11. The method of claim 1, wherein the aerial vehicle is an unmanned aerial vehicle.

12. The method of claim 1, wherein the aerial vehicle is capable of being controlled by a remote.

13. The method of claim 1, wherein the object signature includes a vector.

14. The method of claim 1, wherein the object signature include one or more pixels.

15. The method of claim 1, wherein the mobile object includes an animal.

16. The method of claim 1, wherein the mobile object includes a human.

17. The method of claim 1, wherein the mobile object includes a vehicle.

18. A computer program product embodied on a computer readable medium, comprising:
computer code for sensing a mobile object utilizing one or more sensors coupled to an aerial vehicle;
computer code for generating an object signature for the mobile object utilizing signals received from the one or more sensors; and
computer code for tracking the mobile object utilizing the object signature.

19. An apparatus, comprising:
a sensor for sensing a mobile object utilizing one or more sensors coupled to an aerial vehicle;
a processor for generating an object signature for the mobile object utilizing signals received from the one or more sensors; and
logic for tracking the mobile object utilizing the object signature.
